(19) United States
(12) Patent Application Publication
(10) Pub. No.: US 2024/0424579 A1
(43) Pub. Date: Dec. 26, 2024

(54) TOOL EXCHANGE DEVICE

(71) Applicant: KOGANEI CORPORATION, Koganei-shi, Tokyo (JP)

(72) Inventor: Yu TAKEBAYASHI, Tokyo (JP)

(21) Appl. No.: 18/684,415

(22) PCT Filed: Jul. 6, 2022
(86) PCT No.: PCT/JP2022/026851

§ 371 Date: Feb. 16, 2024

(30) Foreign Application Priority Data
Aug. 17, 2021 (JP) 2021-132698

(51) Int. Cl. B23B 31/107

(52) U.S. Cl. CPC B23B 31/1071; B23B 2260/02; B23B 2260/062

(57) ABSTRACT

A tool exchange device in which a tool unit is detachably attached, the tool exchange device includes: a device body in which a motor accommodation chamber for accommodating an electric motor is formed; a cylindrical member provided in the device body and to which a plurality of balls engaged with an engagement ring provided in the tool unit are attached; a cam member attached inside the cylindrical member and rotated and driven by the electric motor arranged in the motor accommodation chamber; and a ball drive surface provided on the cam member and having a lock surface for engaging the ball with the engagement ring and a release surface for releasing the ball from the engagement ring.

### CROSS-REFERENCE TO RELATED APPLICATIONS

This application is a National Stage application of International Patent Application No. PCT/JP2022/026851, filed on Jul. 6, 2022, which claims priority to Japanese Patent Application No. 2021-132698, filed on Aug. 17, 2021, each of which is hereby incorporated by reference in its entirety.

### TECHNICAL FIELD

The present invention relates to a tool exchange device in which a tool unit is detachably attached.

### BACKGROUND

In order to operate a robot arm to perform an operation(s) of a processing and the like of a workpiece(s), a tool exchange device is attached to the robot arm as a moving device and a tool unit is detachably attached to the tool exchange device. The tool unit is provided with an operating device such as a tool or hand for processing the workpiece or conveying the workpiece or a jig. A plurality of tool units having different operating devices according to a type of operations on the workpiece and the jig are arranged on a support base, and any one of the tool units is attached to the tool exchange device according to the operation.

Patent Document 1 discloses a robot arm coupling device having a master plate attached to the robot arm and a tool plate to which a tool or the like is attached, the master plate being provided with an attachment/detachment mechanism for attaching/detaching the tool plate to/from the master plate. The attachment/detachment mechanism has an insertion portion inserted into an insertion hole portion of a ball receiver of the tool plate, and a ball engaged with an inner peripheral surface of the insertion hole portion is provided in the insertion portion. A piston member for engaging the ball with the insertion hole is provided in the master plate.
Patent Document 1: Japanese Patent Application Laid-open No. 2003-117868

### SUMMARY

### Problems to be Solved by the Invention

Thus, in the coupling device configured to engage the ball with the insertion hole by the piston member, a compressed air supply source for supplying compressed air to the piston member needs to be provided to the moving device such as an industrial robot arm. When a pneumatic actuation device such as an air hand is mounted on the tool plate, a pneumatic supply source for supplying compressed air to the pneumatic actuation device is provided to the moving device, so that compressed air can be supplied from the pneumatic supply source to the piston member.

However, if no pneumatic actuation device is mounted on the tool plate, the pneumatic supply source needs to be provided to the moving device for driving the piston member. Moreover, an air supply hose needs to be provided to the master plate, and providing these spaces in the master plate becomes necessary. Consequently, the coupling device as a tool exchange device and a structure of the master plate become complicated, and a size of the tool exchange device is difficult to be reduced.

An object of the present invention is to provide the tool exchange device having a simple structure.

### Means for Solving the Problems

A tool exchange device of the present invention in which a tool unit is detachably attached, the tool exchange device including: a device body in which a motor accommodation chamber for accommodating an electric motor is formed; a cylindrical member provided in the device body and to which a plurality of balls engaged with an engagement ring provided in the tool unit are attached; a cam member attached inside the cylindrical member and rotated and driven by the electric motor arranged in the motor accommodation chamber; and a ball drive surface provided on the cam member and having a locking surface for engaging the ball with the engagement ring and a release surface for releasing the ball from the engagement ring.

### Effects of the Invention

The tool exchange device has a device body accommodating an electric motor and a cylindrical member to which the ball engaged with the engagement ring of the tool unit is attached. The cam member attached to the cylindrical member has the lock surface for engaging the ball with the engagement ring and the release surface for releasing the ball from the engagement ring, and the cam member is rotated and driven by the electric motor, so that the tool unit can be detachably attached by the tool exchange device having a simple structure.

### BRIEF DESCRIPTION OF THE DRAWINGS

FIG. 1 is a cross-sectional view of a tool exchange device according to one embodiment r;

FIG. 2 is a cross-sectional view of a state of removing a tool unit from the tool exchange device;

FIG. 3 is an exploded view of FIG. 1;

FIG. 4A is a cross-sectional view of a cylindrical member taken along line A-A in FIG. 1, showing a lock state of a ball;

FIG. 4B is a cross-sectional view of a cylindrical member taken along line A-A in FIG. 1, showing a release state of the ball;

FIG. 5 is a front view showing appearances of a tool unit attaching an electric hand as an operation device and a tool exchange device according to another embodiment attached to a robot arm;

FIG. 6 is a cross-sectional view of the tool exchange device shown in FIG. 5;

FIG. 7 is a cross-sectional side view of a tool exchange device according to another embodiment; and

FIG. 8 is a cross-sectional view taken along line B-B in FIG. 7.

### DETAILED DESCRIPTION

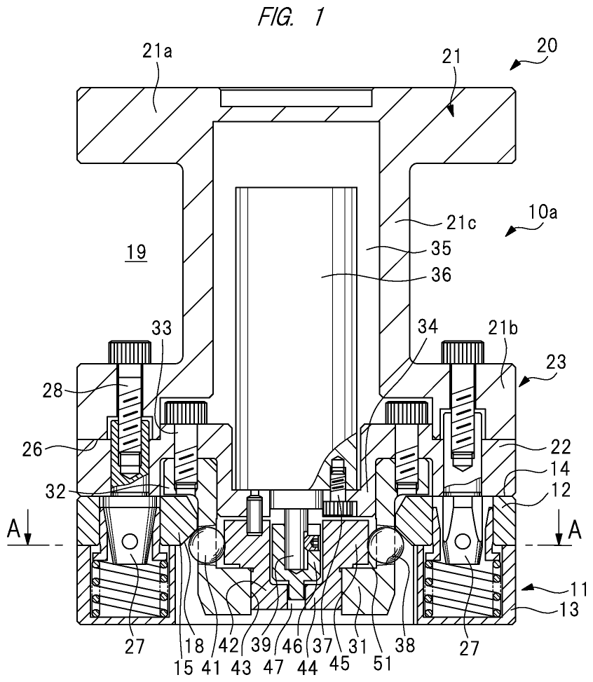

Embodiments of the present invention will be described in detail based on the drawings. As shown in FIGS. 1 to 3, a tool unit 11 is detachably attached to a tool exchange device 10a. The tool unit 11 includes an annular tool block 12 and an annular fastening block 13 attached to a front surface of the tool block 12, a back surface of the tool block 12 being an abutment surface 14. An engaging ring 15 is provided integrally with the tool block 12, the engaging ring 15 has a small diameter through hole 16 formed at a center portion in a direction along a center axis O1, a ball guide surface 17 is provided on a back side of the tool block 12 with respect to the through hole 16, and a ball engaging surface 18 is provided on the front side. The ball guide surface 17 is inclined so as to have a small diameter from the back surface of the tool block 12 toward the through hole 16, and the ball engaging surface 18 is inclined so as to have a large diameter from the through hole 16 toward the front surface of the tool block 12.

An operation device such as an electric hand or an electric driver is configured to be attached to the fastening block 13 of the tool unit 11. Then, this operation device is connected to a controller via a connector and is driven by the controller. By using an operation device attached to the tool unit 11, the tool exchange device 10a is attached to a robot arm (not shown) for processing, conveying, and the like of a workpiece(s) by the robot arm as a moving device. The tool exchange device 10a is also referred to as a master unit or a master plate.

The tool exchange device 10a has a device body 20. The device body 20 includes a motor case 21 and an end plate 22 attached to this tip. The motor case 21 includes a base disk 21a on a back end side attached to the robot arm, an attachment ring 21b on a tip side to which the tool unit 11 is detachably attached, and a center cylindrical body 21c provided between the base disk 21a and the attachment ring 21b. An outer diameter of the center cylindrical body 21c is smaller than outer diameters of the base disk 21a and the attachment ring 21b, and an operation space 19 formed of a concave portion is formed between the base disk 21a and the attachment ring 21b in a radial outward of the center cylindrical body 21c. The end plate 22 is attached to the attachment ring 21b, and an attachment flange 23 is configured by the attachment ring 21b and the end plate 22.

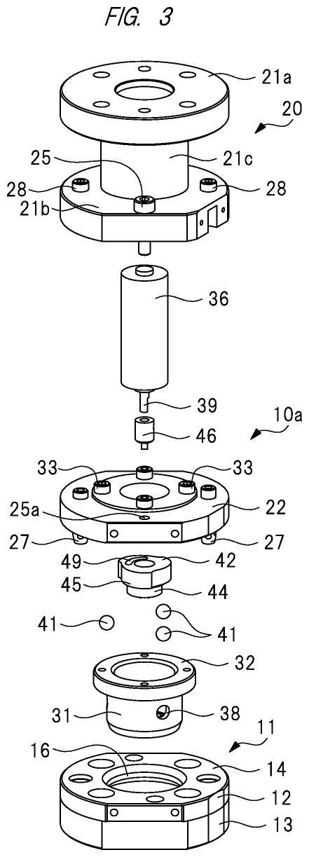

As shown in FIG. 3, a screw hole 25 is formed in the end plate 22, and the end plate 22 is fixed to the attachment ring 21b by the screw member 25 which is screwed into the screw hole 25a. A screw member (not shown) is provided at a position shifted by 180 degrees in a circumferential direction of the attachment ring 21b. An outer periphery portion of the front surface of the end plate 22 is an attachment surface 26 against which the abutment surface 14 of the tool block 12 is abutted. The tool exchange device 10a has, as the front surface, a side on which the attachment surface 26 is formed, and the too unit 11 has, as the back surface, the abutment surface 14 which is abutted against the attachment surface 26.

Two lock pins 27 are attached to the end plate 22 at 180 degrees shifted in the circumferential direction of the end plate 22, and each lock pin 27 is screwed to the screw member 28 attached to the attachment ring 21b.

A cylindrical member 31 is provided on the end plate 22 of the device body 20. The cylindrical member 31 has a flange 32 provided at a base end portion, four screw members 33 penetrating through the attachment hole provided in the end plate 22 are screwed to the flange 32, and the cylindrical member 31 is fixed to the end plate 22 by the screw member 33. The cylindrical portion 34 is provided at a radial center portion of the end plate 22, and a motor accommodation chamber 35 is formed inside the device body 20 by the cylindrical portion 34 and the center cylindrical body 21c. An electric motor 36 is arranged in the motor accommodation chamber 35, and the electric motor 36 is positioned inside the cylindrical portion 34 and is fixed to the end plate 22 by the screw member 37. Power is supplied to the electric motor 36 from the outside via the connector (not shown) provided in the device body 20.

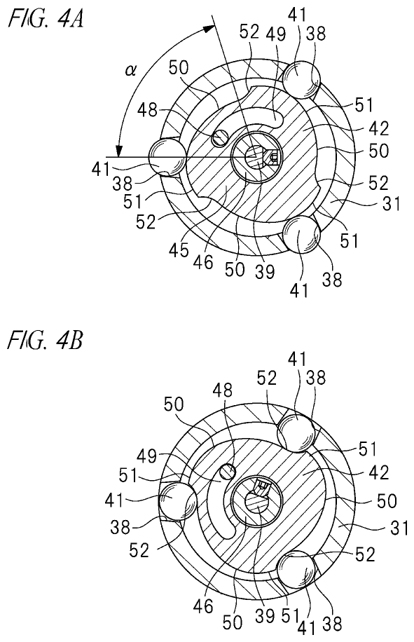

As shown in FIGS. 4A and 4B, three ball support holes 38 are formed at equal intervals in the circumferential direction in the cylindrical member 31, the ball support holes 38 penetrate through the cylindrical member 31 in the radial direction, and an inner diameter of the cylindrical member 31 gradually decreases toward the radial outside of the cylindrical member 31. A steel ball, that is, a ball 41 is attached in each ball support hole 38, and the ball 41 is not disengaged from radial outward the ball support hole 38. The cam member 42 is attached inside the cylindrical member 31, and the cam member 42 includes a drive portion 44 rotatably attached to a support hole 43 formed at a tip portion of the cylindrical member 31 and a cam portion 45 integrated therewith.

The coupling member 46 is attached to the shaft 39 of the electric motor 36, and the coupling member 46 meshes with an engagement hole 47 formed in the drive portion 44 of the cam member 42. A rotation center axis O2 of the shaft 39 is coaxial with a rotation center axis of the cam member 42, and the electric motor 36 is arranged in the motor case 21 of the device body 20 in the vertical direction so that the shaft 39 is oriented along the rotation center axis of the cam member 42. The guide pin 48 protrudes into the cam member 42 and is attached to the end plate 22, a guide hole 49 into which the guide pin 48 enters is formed in an arc shape on the cam member 42, and the reciprocation and the rotation of the cam member 42 are guided by the guide pin 48. The electric motor 36 causes the cam member 42 to reciprocate within a range of angle α, as indicated by an arrow in FIGS. 4A and 4B. This angle α is about 80 degrees. A reciprocation rotation angle of the cam member 42 is regulated by a guide pin 48.

As shown FIGS. 4A and 4B, three ball drive surfaces 50 are formed on the outer peripheral surface of the cam portion 45 of the cam member 42, and each ball drive surface 50 is provided in a range of 120 degrees in the circumferential direction. Each ball drive surface 50 includes: a large-diameter locking surface 51 whose radius is maximum from a rotation center axis of the cam member 42; and a release surface 52 having a smaller diameter than the locking surface 51, and the radius of the ball drive surface 50 changes so that the diameter gradually decreases from the locking surface 51 toward a release surface 52. As shown in FIG. 4A, when each ball 41 contacts the locking surface 51, a portion of the ball 41 protrudes radially outward from an outer peripheral surface of the cylindrical member 31 and is engaged with the ball engagement surface 18 of the engagement ring 15. This allows the abutment surface 14 of the tool unit 11 to be abutted against the attachment surface 26 of the tool exchange device 10a to fasten the tool unit 11 to the tool exchange device 10a.

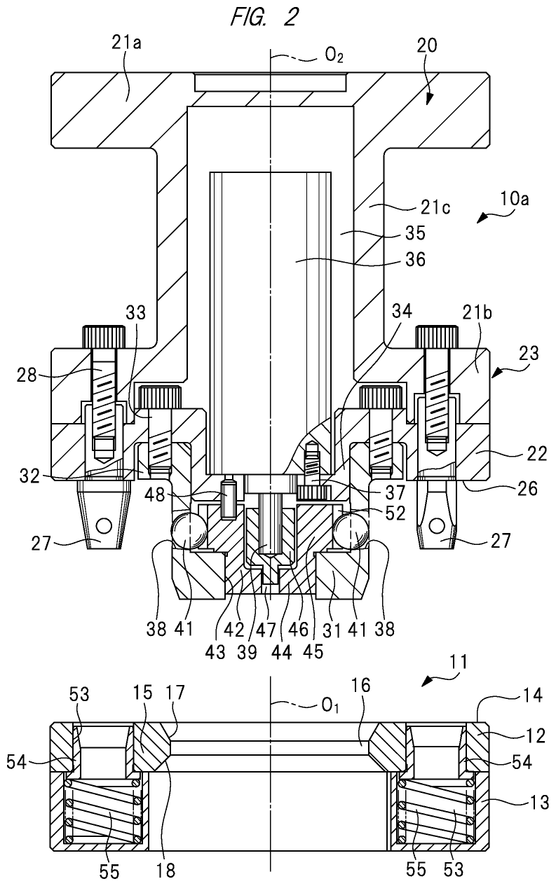

Meanwhile, as shown in FIG. 4B, when the cam member 42 is rotated counterclockwise from a position of FIG. 4A, each ball 41 contacts with the release surface 52 and the ball 41 does not protrude outward from the outer peripheral surface of the cylindrical member 31. In this state, as shown in FIG. 2, the tool exchange device 10a can be separated from the tool unit 11.

As shown in FIGS. 1 and 2, a fastening hole 53 into which the lock pin 27 is inserted is formed in the fastening block 13, and a sleeve 54 that is fitted into the lock pin 27 is movably attached to the fastening hole 53. The lock pin 27 has a tapered shape in which a tip end portion has a smaller diameter than the base end portion, and an inner peripheral surface of the sleeve 54 has a tapered portion whose inner diameter decreases toward the tip portion. A compression coil spring 55 is attached to the fastening hole 53 and a spring force of the compression coil spring 55 is applied to the sleeve 54 in a direction toward the lock pin 27. The compression coil spring 55 and the sleeve 54 improve fastening accuracy between the tool unit 11 and the tool exchange device 10a.

To attach the tool unit to the tool exchange device 10a attached to the robot arm as the moving device, the cylindrical member 31 is inserted into the through-hole 16 of the tool unit 11 under a state in which the three balls 41 contact with the release surface 52 and the ball does not protrude from the outer peripheral surface of the cylindrical member, as shown in FIGS. 2 and 4B. Consequently, the lock pin 27 is inserted into the sleeve 54, and the rotation of the tool unit 11 with respect to tool exchange device 10a is restricted. Under the condition that the attachment surface 26 of the tool exchange device 10a is abutted against the abutment surface 14 of the tool unit 11, the electric motor 36 is driven to rotate and drive the shaft 39, and the lock surface 51 of the cam member 42 is caused to contact with the ball 41. Thus, as shown in FIGS. 1 and 4A, the ball 41 contacts with the ball engagement surface 18 of the engagement ring 15 and the tool unit 11 is fastened to the tool exchange device 10a.

In this way, the tool unit 11 is fastened to the tool exchange device 10a by rotating the cam member 42 by the electric motor 36, and the fastening is released by rotating it in an opposite direction to that at the fastening time, so that the tool exchange device 10a can have a simple structure. The electric motor 36 is longitudinally arranged in the motor case 21 of the device body 20 and can reduce lateral dimension of the device body 20, namely, dimension in a direction transverse to the rotation center axis O2.

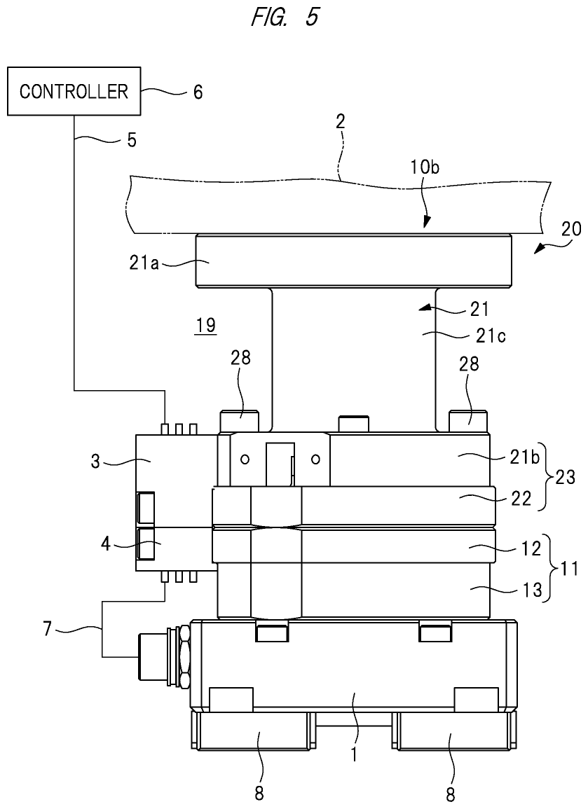

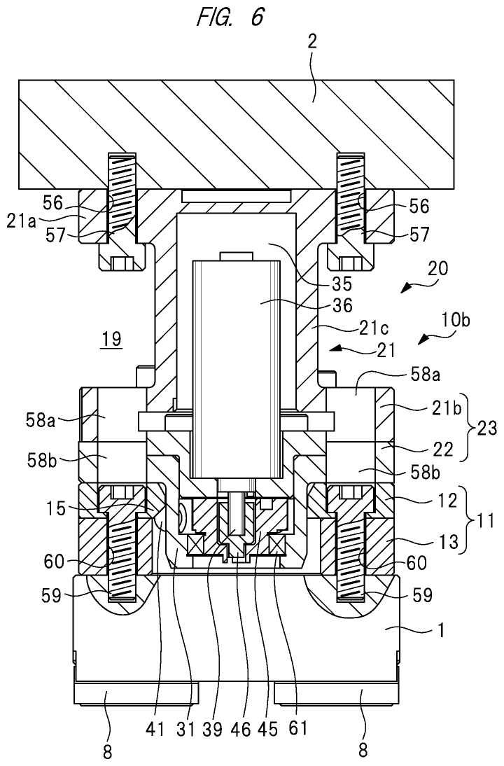

FIG. 5 is a front view showing an appearance of the tool unit 11 to which the electric hand 1 as the operation device is attached and a tool exchange device 10b that is another embodiment attached to the robot arm 2, and FIG. 6 is a cross-sectional view of the tool exchange device 10b shown in FIG. 5. In the tool exchange device 10b shown in FIGS. 5 and 6, the same reference numerals are applied to members having commonality with the tool exchange device 10a described above.

As shown in FIG. 5, a body side connector 3 is provided on an attachment flange 23 of the device body 20, and a tool side connector 4 is provided in a tool block 12 of the tool unit 11. The body side connector 3 is connected to the controller 6 arranged in a robot control portion by a signal line 5, and the tool side connector 4 is connected to the electric hand 1 by a signal line 7. The tool exchange device 10b moves a predetermined movement path along with the electric hand 1 by the robot arm 2. The electric hand 1 has two fingers 8 for gripping the workpiece or the like, and the fingers 8 are movable toward and away from each other. A gripping operation of the workpiece or the like by the finger 8 of the electric hand 1 at a predetermined position and a releasing operation of the gripped workpiece or the like are performed by controlling the electric hand 1 by the signal from the controller 6.

As shown in FIG. 6, a through-hole 56 is formed in a base disc 21a of the motor case 21 configuring the device body 20, and a screw member 57 screwed to the robot arm 2 is attached to the through-hole 56. A head of the screw member 57 is at a position radially outward of the center cylindrical body 21c and is exposed to an operation space 19 formed between the base disk 21a and the attachment ring 21b.

A plurality of through-holes 58a are formed in the attachment ring 21b configuring the attachment flange 23, and a through-hole 5b is formed in the end plate 22 so as to correspond to the through-hole 58a. Each of the through-holes 58a, 58b is open to the operation space 19 and is used to attach the screw member 59 for attaching the electric hand 1 to the tool exchange device 10b. The screw member 59 is attached to a through-hole 60 formed in the tool unit 11.

In the tool exchange device 10b, when the tool exchange device 10b is attached/detached to/from the robot arm 2, the screw member 57 can be attached/detached to/from the convex operation space 19, and the tool exchange device 10b can be attached/detached to/from the robot arm 2 even while the tool unit 11 is fastened to the tool exchange device 10b. Further, when the operation device such as the electric hand 1 is attached/detached to/from the tool unit 11, the screw member 59 can be attached/detached to/from the operation space 19 via the through-holes 58a, 58b. Consequently, even while the tool unit 11 is fastened to the tool exchange device 10b, the attaching/detaching can be operated with respect to the tool unit 11 of the electric hand 1.

In this way, the present embodiment adopts such a structure that the screw member can be attached/detached to/from the operation space 19 for the radially outward attachment/detachment operation of the center cylindrical body 21c, so that for example, even when the tool exchange device 10b and the tool unit 11 cannot be separated from each other due to some inconvenience, the operation device such as the electric hand 1 can be replaced with the tool unit 11 or the tool exchange device lob can be removed from the robot arm 2.

In the cylindrical member 31 attached to the end plate 22, three balls 41 are attached in the same manner as the tool exchange device 10a shown in FIGS. 1 and 2, and the tool block 12 is provided with the engagement ring 15 with which the respective balls 41 are engaged. Further, a ball drive surface 50 similar to that shown in FIGS. 4A and 4B is formed on an outer circumferential surface of a cam portion 45 of the cam member 42 driven by the shaft 39 of the electric motor 36. Moreover, the cam member 42 is rotatably supported by the cylindrical member 31 via a bearing 61.

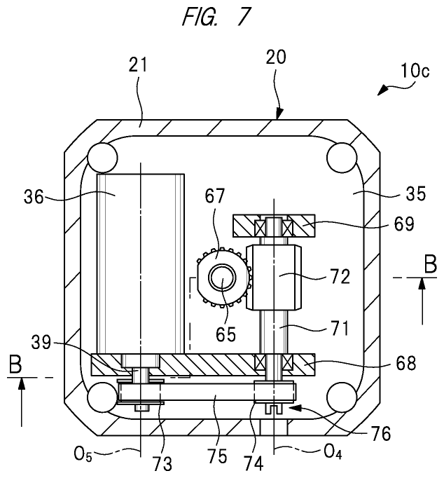

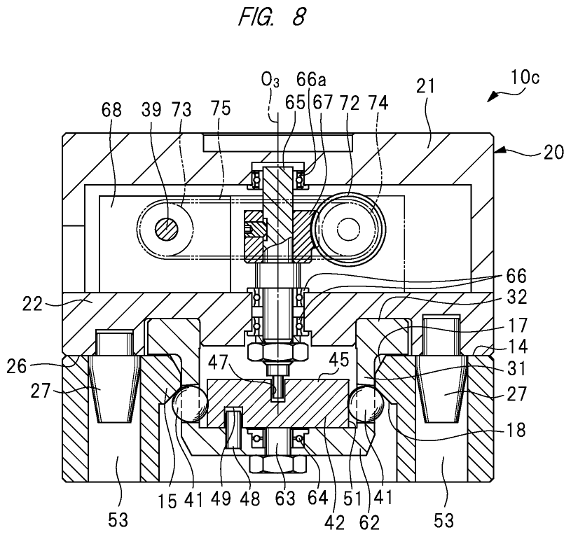

FIG. 7 is a top cross-sectional view of a tool exchange device 10c according to another embodiment, and FIG. 8 is a cross-sectional view taken along line B-B in FIG. 7. In the tool exchange device 10c shown in FIGS. 7 and 8, the same reference numerals are applied to members having commonality with the tool exchange devices 10a, 10b described above.

The device body 20 includes the motor case 21 having a square cross-sectional shape and the end plate 22 attached to a tip portion thereof. The tool unit 11 is integrally provided with the engagement ring 15 and has the fastening hole 53 formed therein. The lock pin 27 is attached to the end plate 22 and protrudes from the attachment surface 26. Note that the sleeve 54 and the compression coil spring 55 shown in FIGS. 1 and 2 may be attached to the tool exchange device 10c. In that case, the number of parts configuring the tool exchange device 10c is increased, but fastening accuracy is improved.

The cam member 42 is rotatably attached to the tip wall 62 of the cylindrical member 31 attached to the end plate 22. A support shaft 63 provided on the cam member 42 is rotatably supported by the bearing 64 on the tip wall 62. The guide pin 48 fixed to the tip wall 62 is inserted into the guide hole 49 in the same manner as the cam member 42 described above, and the cam member 42 is guided by the guide pin 48 to reciprocate in the range of angle α in the same manner as described above. As in the case described above. The cam member 42 has three ball drive surfaces formed on the outer circumferential surface of the cam portion 45 similarly to the above-mentioned case, and each ball drive surface includes a large-diameter lock surface 51 and a small-diameter release surface 52.

The drive shaft 65 is rotatably supported by the bearing 66 on the end plate 22, rotatably supported by the motor case 21 by the bearing 66a, and the tip portion of the drive shaft 65 is engaged with the engagement hole 47 formed in the cam member 42. A rotation center axis O3 of the drive shaft 65 is coaxial with the rotation center axis of the cam member 42. A worm gear 67 is attached to the drive shaft 65. A main support plate 68 and a sub-support plate 69 are provided parallel to each other in the end plate 22 positioned by the motor accommodation chamber 35, and a worm 72 meshing with the worm gear 67 is provided in the worm shaft 71 whose both end portions are rotatably supported. A rotation center axis O4 of the worm shaft 71 is perpendicular to the rotation center axis O3 of the drive shaft 65.

The electric motor 36 is attached to the main support plate 68, a rotation center axis O5 of the electric motor 36 is parallel to the rotation center axis O4 of the worm shaft 71, and the electric motor 36 is arranged laterally in the motor accommodation chamber 35. A belt 75 is bridged between a pulley 73 attached to the shaft 39 of the electric motor 36 and a pulley 74 attached to the worm shaft 71, and the pulleys 73, 74 and the belt 75 configures a rotation transmission mechanism 76 that transmits the rotation of the shaft 39 of the electric motor 36 to the worm 72.

In this manner, when the electric motor 36 is laterally arranged in the device body 20, the longitudinal dimension of the tool exchange device 10b, namely, the dimension in the direction along the rotation center axis O3 can be reduced, and the rotation transmission mechanism 76 for transmitting the rotation of the shaft 39 to the worm 72 can be arranged in the motor accommodation chamber 35. Moreover, similarly to the tool exchange device 10a, 10b described above, by rotating the cam member 42 by the electric motor 36, the tool unit 11 is fastened to the tool exchange device 10b, while the fastening is released by rotating it in the opposite direction to that at the fastening time, so that the tool exchange device 10c can adopt a simple structure.

The present invention is not limited to the embodiments described above, but can variously be modified without departing from the scope thereof. The number of ball drive surfaces 50 formed on the outer circumferential surface of the cam portion 45 of the cam member 42, namely, the number of balls 41 is not limited to three, and may be four or more according to the diameter of the cylindrical member 31 as long as it is plural. Further, although a case where the tool exchange device is attached to the robot arm has been described, it is possible to apply the tool exchange device of the present invention if it is not limited to the robot arm and is the moving device provided with a member(s) for moving the tool unit.

### INDUSTRIAL APPLICABILITY

The tool exchange device according to the present invention can be used to detachably attach the tool unit by a simple structure.

1. A tool exchange device in which a tool unit is detachably attached, the tool exchange device comprising:
a device body in which a motor accommodation chamber for accommodating an electric motor is formed;
a cylindrical member provided in the device body and to which a plurality of balls engaged with an engagement ring provided in the tool unit are attached;
a cam member attached inside the cylindrical member and rotated and driven by the electric motor arranged in the motor accommodation chamber; and
a ball drive surface provided on the cam member and having a lock surface for engaging the ball with the engagement ring and a release surface for releasing the ball from the engagement ring.

2. The tool exchange device according to claim 1,
wherein a shaft of the electric motor is directed toward a direction along a rotation center axis of the cum member, and the electric motor is arranged longitudinally in the device body.

3. The tool exchange device according to claim 1,
wherein an operation device is attached to the tool unit;
the device body includes a base disk attached to a moving device, an attachment flange to which the tool unit is attached, and a center cylindrical body arranged between the base disk and the attachment flange and having a smaller diameter than those of the base disk and the attachment flange,
an operation space for attachment/detachment operations of a screw member for fastening the base disk to the moving device and a screw member for fastening the operation device to the tool unit is provided radially outward in the center cylindrical body.

4. The tool exchange device according to claim 1,
wherein a worm gear attached to a drive shaft of the cam member, a worm meshing with the worm gear, and a rotation transmission mechanism for transmitting rotation of a shaft of the electric motor to the worm are arranged in the motor accommodation chamber, and the shaft is directed toward a lateral direction with respect to a rotation center axis of the cam member and the electric motor is laterally arranged in the device body.

5. The tool exchange device according to claim 1,
wherein three balls composed of the ball are equally spaced in a circumferential direction and attached to the cylindrical member, three ball drive surfaces are formed on the cam member, and a diameter of the ball drive surface gradually changes from the large diameter lock surface to the small diameter releasing surface.

6. The tool exchange device according to claim 1, further comprising:
a guide hole provided in the cam member; and
a guide pin provided so as to protrude from the device body to the cam member,
wherein the guide pin enters the guide hole to restrict rotation of the cam member.

7. The tool exchange device according to claim 1, further comprising a lock pin that is fitted into a fastening hole provided in the tool unit and restricts the rotation of the tool unit with respect to the device body.
